(19) United States
(12) Patent Application Publication
(10) Pub. No.: US 2026/0349234 A1
(43) Pub. Date: Nov. 5, 2026

(54) REFLECTION-MODE QUANTITATIVE PHASE MICROSCOPE AND METHOD BASED ON NEAR-INFRARED VORTEX-SPECKLE ILLUMINATION

(71) Applicant: The Chinese University of Hong Kong, Hong Kong (CN)

(72) Inventors: Renjie Zhou, Hong Kong (CN); Chaodu Shi, Hong Kong (CN); Nansen Zhou, Hong Kong (CN); Qihang Zhang, Hong Kong (CN)

(21) Appl. No.: 19/655,746

(22) Filed: Apr. 23, 2026

(30) Foreign Application Priority Data
Apr. 24, 2025 (CN) 202510525813.0

(51) Int. Cl. G02B 21/36; G01B 9/02; G06T 12/10; H04N 23/74

(52) U.S. Cl. CPC G02B 21/365; G01B 9/02041; G01B 9/02083; G06T 12/10; H04N 23/74

(57) ABSTRACT

Disclosed is a reflection-mode quantitative phase microscope and method based on near-infrared vortex speckle illumination. The microscope include: a vortex light generation unit to generate vortex light in the near-infrared wavelength; a random speckle modulation component to apply random phase modulation to the vortex light to obtain vortex speckle illumination; a Köhler illumination unit to perform an optical Fourier transform on the vortex speckle to output uniformly intense vortex speckle illumination; a reflection-mode imaging unit configured to direct the vortex speckle illumination through an objective lens onto a sample, achieve optical sectioning by introducing a coherence-gating effect, perform axial scanning of the sample, and collect signal light reflected from the sample to obtain intensity images; a common-path interferometer to process the intensity images to obtain interferometric images of the sample at different axial positions; and a detection unit configured to collect the interferometric images for three-dimensional phase reconstruction. The application achieves high-precision optical sectioning. Additionally, by extending the spatial frequency, it improves the spatial resolution.

### CROSS REFERENCE TO RELATED APPLICATIONS

The present application claims the benefit of Chinese Patent Application No. 202510525813.0 filed on Apr. 24, 2025, the contents of which are incorporated herein by reference in their entirety.

### TECHNICAL FIELD

The present invention pertains to microscopy-based characterization method. In particular, the invention pertains to a reflection-mode quantitative phase microscope and method based on near-infrared vortex speckle illumination.

### BACKGROUND OF THE INVENTION

Since the beginning of the 21st century, semiconductor technology has developed rapidly. However, as transistor dimensions approach physical limits, conventional two-dimensional chip fabrication techniques face increasing challenges in scaling down transistor sizes. To increase storage density and performance to meet the demands of modern electronic devices for high capacity and low power consumption, three-dimensional (3D) stacked chips have been developed. As the number of stacked layers increases, the impact of defects introduced during fabrication on device performance becomes increasingly significant. Consequently, 3D structural measurement techniques and defect detection methods for high-stack-count structures have become critical for improving yield. Although scanning transmission electron microscopy and energy-dispersive X-ray spectroscopy can accurately analyze variations in channel dimensions, shapes, and dielectric layer widths, their high cost, slow imaging speed, and limitations in quantitative analysis accuracy and spatial resolution restrict their efficiency in inspecting 3D stacked chips. Furthermore, in the field of medical diagnostics, in vivo observation of cells and even subcellular structures is required, as all environmental factors that regulate physiological processes exist only in living organisms. This imposes stringent requirements on the imaging depth of imaging systems. To avoid the effects of phototoxicity and photobleaching on cells, label-free imaging techniques have become essential for live-cell imaging. In summary, both the semiconductor field and the life sciences require high-resolution, label-free, quantitative characterization methods for thick structures.

Quantitative phase imaging is an advanced label-free optical imaging technique that quantifies the morphology and refractive index distribution of a sample by measuring the phase changes induced in light waves as they pass through the sample, without the need for staining or labeling. The diffraction tomography techniques developed from quantitative phase imaging enable three-dimensional phase reconstruction at the diffraction limit (approximately 300 nm laterally and 600 nm axially), showing great promise in metrology and the characterization of cellular structures. However, due to their use of transmission-mode laser interferometric geometries, most current diffraction tomography systems have limited imaging depths (<20 μm), which leads to increased absorption and multiple scattering. By exploiting the coherent gating effect and a reflection-mode geometry, speckle diffraction tomography has recently been developed, achieving imaging depths exceeding 500 μm in biological tissues. Nevertheless, the imaging depth remains insufficient to support the application demands of stacked chip structural characterization and in vivo imaging.

### BRIEF SUMMARY OF THE INVENTION

To address the limitations of the prior art, the present application provides a reflection-mode quantitative phase microscope and method based on near-infrared vortex speckle illumination.

### Methodology of This Innovation

A reflection-mode quantitative phase microscope based on near-infrared vortex speckle illumination is provided, including: a vortex light generation unit configured to generate vortex light in the near-infrared band; a random speckle modulation unit configured to apply random speckle modulation to the vortex light to obtain vortex speckle; a Köhler illumination unit configured to perform an optical Fourier transform on the vortex speckle to output uniformly intense vortex speckle illumination; a reflection-mode imaging unit configured to direct the uniformly intense vortex speckle illumination output from the Köhler illumination unit through an objective lens onto a sample, achieve optical sectioning by introducing a time-gating effect, perform axial scanning of the sample, and collect signal light reflected from the sample to obtain intensity images of the sample; a common-path interferometer configured to process the intensity images to obtain interferometric images of the sample at different axial positions; and a detection unit configured to collect the interferometric images, wherein the interferometric images are used for three-dimensional (3D) phase reconstruction of the sample.

Secondly, a reflection-mode quantitative phase imaging method based on near-infrared vortex speckle illumination is provided, comprising the following steps:
S1: generating vortex light in the near-infrared band;
S2: applying random speckle modulation to the vortex light to obtain vortex speckle;
S3: performing an optical Fourier transform on the vortex speckle to obtain uniformly intense vortex speckle illumination;
S4: directing the uniformly intense vortex speckle illumination through an objective lens onto a sample in a reflection-mode imaging configuration, achieving optical sectioning by introducing a time-gating effect, performing axial scanning of the sample, and collecting signal light reflected from the sample to obtain intensity images of the sample;
S5: processing the intensity images via a common-path interferometric scheme to obtain interferometric images of the sample at different axial positions; and
S6: collecting the interferometric images to achieve 3D phase reconstruction of the sample.

The improvements of this innovation include: The microscope and imaging method of the present application employ illumination light operating in the near-infrared band to reduce scattering and absorption of the illumination light by the sample. By employing vortex speckle illumination in conjunction with a reflection-mode imaging configuration, a time-gating effect is introduced, achieving high-precision optical sectioning while extending the spatial frequency, thereby improving spatial resolution. The present application enables large-thickness characterization in scattering media, offering advantages such as high imaging depth and high spatial resolution. It can be used for large-depth structural characterization of semiconductor materials or deep-tissue imaging, meeting the demands for stacked chip characterization and in vivo imaging.

### BRIEF DESCRIPTION OF THE DRAWINGS

FIG. 1A is a schematic diagram of the reflection-mode quantitative phase microscope based on near-infrared vortex speckle illumination according to an embodiment of the present application.

FIG. 1B shows interferometric images and corresponding camera grayscale histogram.

FIG. 2A shows the annular intensity distributions of vortex light for a of 0.1 and 0.3, respectively.

FIG. 2B shows the intensity distributions of vortex speckles for a of 0.1 and 0.3, respectively.

FIG. 2C shows the spatial frequency spectra of vortex speckle illumination for a of 0.1 and 0.3, respectively.

FIGS. 3A-3C present theoretical simulation results of the point spread function and coherent transfer function in the embodiment.

FIG. 4 is a comparison of optical sectioning capability between vortex speckle illumination and Gaussian speckle illumination at a=0.3.

FIG. 5A is a schematic diagram of the biological tissue model structure used to verify the imaging depth of the embodiment.

FIG. 5B is a phase image of a 10 mm diameter polystyrene sphere sample at the bottom of the biological tissue model, measured at thicknesses of 0 mm, 0.5 mm, 1 mm, and 1.5 mm.

FIG. 5C is a phase image of a red blood cell sample at the bottom of the biological tissue model, measured at thicknesses of 0.5 mm, 1 mm, and 1.5 mm.

FIG. 5D shows the detection results of deposition defects in the three-dimensional stacked chip sample buried under a silicon nitride and silicon oxide multilayer film structure at an illumination wavelength of 800 nm.

FIG. 5E shows the detection results of deposition defects in the three-dimensional stacked chip sample buried under a silicon nitride and silicon oxide multilayer film structure at an illumination wavelength of 1300 nm.

### DETAILED DISCLOSURE OF THE INVENTION

Embodiments of the present invention will be described in detail below. It should be emphasized that the following description is exemplary only and is not intended to limit the scope of the present invention or its applications. Where no conflict arises, the embodiments and features described in this application may be combined with one another.

Currently, in the fields of semiconductor technology and biomedical, there is a strong demand for optical imaging tools capable of quantitative detection and structural characterization at large depths. However, existing optical imaging tools cannot meet these demands due to limitations in imaging depth and spatial resolution. To address these challenges, the present disclosure provides a reflection-mode quantitative phase microscope based on near-infrared vortex speckle illumination (hereinafter also referred to simply as “the microscope”). The microscope is based on reflection-mode quantitative phase imaging and avoids the missing-cone problem in imaging by combining vortex illumination and speckle illumination. The microscope comprises:
A vortex light generation unit configured to generate vortex light in the near-infrared wavelength;
A random speckle modulation unit configured to apply random speckle modulation to the vortex light to obtain vortex speckle illumination;
A Köhler illumination unit configured to perform an optical Fourier transform on the vortex speckle to output uniformly intense vortex speckle illumination;
A reflection-mode imaging unit configured to direct the uniformly intense vortex speckle illumination output from the Köhler illumination unit through an objective lens onto a sample, achieve optical sectioning by introducing a time-gating effect, perform axial scanning of the sample, and collect signal light reflected from the sample to obtain intensity images of the sample;
A common-path interferometer configured to process the intensity images to obtain interferometric images of the sample at different axial positions; and
A detection unit configured to collect the interferometric images, wherein the interferometric images are used for 3D phase reconstruction of the sample.

In some implementations, the vortex light is a perfect vortex light, and the vortex light generation unit comprises a near-infrared light source and generates the vortex light by means of laser oscillation or phase modulation. Specifically, the perfect vortex light is generated either directly by the near-infrared light source via laser oscillation, or by generating Gaussian light from the near-infrared light source and then phase-modulating the Gaussian light to produce the perfect vortex light.

In some implementations, when the vortex light generation unit generates the vortex light by means of phase modulation, the vortex light generation unit further comprises a phase modulator and a first lens. The near-infrared light source is configured to generate Gaussian light. The phase modulator is configured to phase-modulate the Gaussian light to generate a Bessel beam. The distance between the first lens and the phase modulator is equal to the focal length of the first lens, and the first lens is configured to perform an optical Fourier transform on the Bessel beam and to obtain the perfect vortex light at the back focal plane of the first lens.

In some implementations, the phase modulator is a spatial light modulator or a phase plate.

In some implementations, the near-infrared light source can be one of a semiconductor laser, a fiber laser, or a solid-state laser. The type of laser output by the near-infrared light source can be one of single-frequency laser, single-wavelength laser, supercontinuum laser, random laser, ultrafast laser, or amplified spontaneous emission laser. The spectral bandwidth of the near-infrared light source can range from the femtometer scale (kilohertz scale) to the micrometer scale (petahertz scale). The near-infrared light source can be configured for continuous-wave or pulsed output. The central wavelength of the near-infrared light source can range from short-wave infrared to long-wave infrared, and the wavelength can be optimized according to the optical properties of the sample.

In some implementations, the vortex speckle illumination is dynamic speckle. The random speckle modulation unit comprises a rotating diffuser or a digital micromirror device loaded with a dynamic speckle pattern, and the rotating diffuser or the digital micromirror device loaded with a dynamic speckle pattern is configured to apply random speckle modulation to the vortex light to obtain vortex speckle.

In some implementations, the Köhler illumination unit is a second lens. The second lens is configured to perform an optical Fourier transform on the vortex speckle to output uniformly intense vortex speckle illumination. The Köhler illumination unit provides uniformly intense vortex speckle illumination, which is then delivered to the sample via the reflection-mode imaging unit, achieving uniform illumination of the sample.

In some implementations, the reflection-mode imaging unit is a Michelson interferometer. The Michelson interferometer is configured to receive the uniformly intense vortex speckle illumination output from the Köhler illumination unit and to generate signal light and reference light with mutually orthogonal polarization states. Then, in the common-path interferometer, the signal light and the reference light are made to interfere, producing interferometric images at the detection unit.

More preferably, the Michelson interferometer comprises a λ/2 waveplate, a third lens, a polarizing beam splitter, a first λ/4 waveplate, a second λ/4 waveplate, a first objective lens, a second objective lens, a fourth lens, and a third mirror, where λ denotes the wavelength. The third lens and the first objective lens, the third lens and the second objective lens, the first objective lens and the fourth lens, and the second objective lens and the fourth lens each form a 4f system. The λ/2 waveplate is configured to receive the uniformly intense vortex speckle illumination output from the Köhler illumination unit, adjust its polarization state, and direct it through the third lens into the polarizing beam splitter. The polarizing beam splitter is configured to adjust the optical power entering the sample arm and the reference arm such that the polarization states of the vortex speckle illumination entering the sample arm and the reference arm are mutually orthogonal. The first λ/4 waveplate and the first objective lens are disposed in the sample arm. The first vortex speckle illumination split by the polarizing beam splitter passes sequentially through the first λ/4 waveplate and the first objective lens to illuminate the sample. The sample reflects the light to generate signal light. The first λ/4 waveplate is configured to modulate the polarization state of the first vortex speckle illumination to circular polarization. The second λ/4 waveplate, the second objective lens, and the third mirror are disposed in the reference arm. The second vortex speckle illumination split by the polarizing beam splitter passes sequentially through the second λ/4 waveplate and the second objective lens to illuminate the third mirror. The third mirror reflects the light to generate reference light. The second λ/4 waveplate is configured to modulate the polarization state of the second vortex speckle illumination to circular polarization. The signal light passes sequentially through the first objective lens, the first λ/4 waveplate, and the polarizing beam splitter, then enters the fourth lens, and subsequently enters the common-path interferometer. The reference light passes sequentially through the second objective lens, the second λ/4 waveplate, and the polarizing beam splitter, then enters the fourth lens, and subsequently enters the common-path interferometer. The polarizing beam splitter can be a polarizing beam splitting prism or a fiber-optic polarizing beam splitting device.

In some implementations, the common-path interferometer comprises a Wollaston prism, a fifth lens, a sixth lens, and a polarizer. The detection unit is a camera. The fifth lens and the sixth lens form a 4f system. The Wollaston prism is placed at the front focal plane of the fifth lens, and the camera is placed at the back focal plane of the sixth lens. The Wollaston prism is configured to receive the signal light and reference light transmitted from the Michelson interferometer. The orthogonal polarized light will be separated with a predetermined angle, and directed through the fifth lens to the sixth lens. Finally, they will be recombined at the back focal plane of the sixth lens. A polarizer is placed between the camera and the sixth lens, with its polarization direction oriented at 45° relative to both the signal light and the reference light. Thus, interferometric images of the sample at different axial positions are obtained, and these interferometric images are further used for 3D phase reconstruction of the sample.

In some implementations, the objective lens can be a microscope objective lens, a microlens, or other types of lenses.

A reflection-mode quantitative phase imaging method based on near-infrared vortex speckle illumination is provided, comprising the following steps:
S1: generating vortex light in the near-infrared band;
S2: applying random speckle modulation to the vortex light to obtain vortex speckle;
S3: performing an optical Fourier transform on the vortex speckle to obtain uniformly intense vortex speckle illumination;
S4: directing the uniformly intense vortex speckle illumination through an objective lens onto a sample in a reflection-mode imaging configuration, achieving optical sectioning by introducing a time-gating effect, performing axial scanning of the sample, and collecting signal light reflected from the sample to obtain intensity images of the sample;
S5: processing the intensity images via a common-path interferometric scheme to obtain interferometric images of the sample at different axial positions; and
S6: collecting the interferometric images to achieve 3D phase reconstruction of the sample.

The present application will be described in detail below through a specific example.

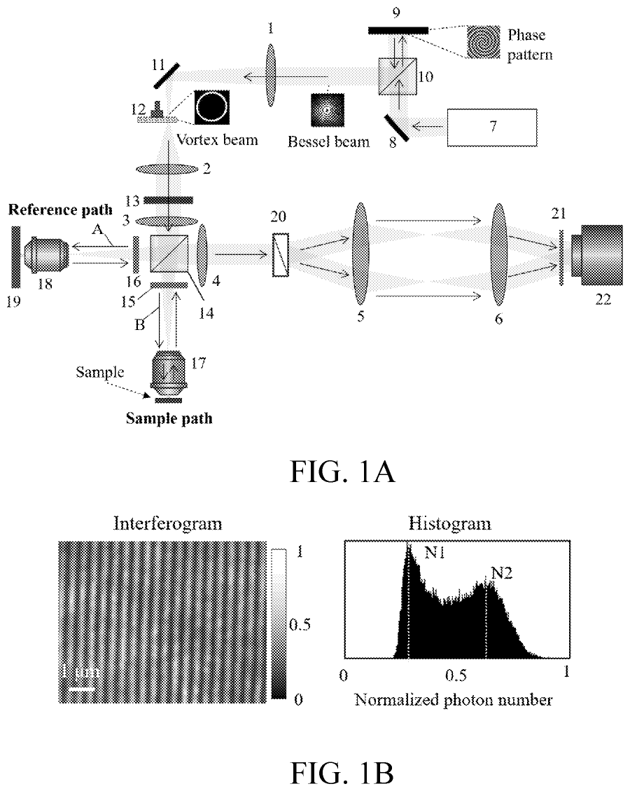

FIG. 1A shows a schematic diagram of a microscope, in which all the lenses are convex lenses.

The vortex light generation unit comprises a near-infrared light source 7, a first mirror 8, a spatial light modulator 9, a beam splitting prism 10, and a first lens 1. In this embodiment, the near-infrared light source 7 has a central wavelength of 1300 nm and a bandwidth of 12 nm, and is configured to generate Gaussian light. The first mirror 8 is configured to reflect the Gaussian light through the beam splitting prism 10 to the spatial light modulator 9. A phase pattern of exp(iar+ilθ) is applied to the spatial light modulator 9, where a is the axicon parameter (a is optimized according to the clear aperture of the objective lens such that the diameter of the vortex light equals the clear aperture of the objective lens), l is the topological charge, r is the radial coordinate, and θ is the azimuthal angle. The spatial light modulator 9 is configured to phase-modulate the Gaussian light to generate a Bessel beam. The Bessel beam is reflected by the beam splitting prism 10 and then enters the first lens 1. The distance between the first lens 1 and the spatial light modulator 9 is equal to the focal length of the first lens 1. The first lens 1 is configured to perform an optical Fourier transform on the Bessel beam and to obtain perfect vortex light at the back focal plane of the first lens 1. In other embodiments, the first mirror 8 and/or the beam splitting prism 10 may be omitted, and the Gaussian light generated by the near-infrared light source 7 is phase-modulated by the spatial light modulator 9, and the resulting Bessel beam is reflected into the first lens. In other embodiments, the vortex light may also be generated directly by the near-infrared light source via laser oscillation. In other embodiments, the spatial light modulator may be replaced by a phase plate.

The vortex speckle illumination is dynamic speckle. The random speckle modulation unit comprises a second mirror 11 and a rotating diffuser 12. The rotating diffuser 12 is placed at the back focal plane of the first lens 1. The second mirror 11 is configured to reflect the perfect vortex light emerging from the first lens 1 onto the rotating diffuser 12. The rotating diffuser 12 is configured to apply random speckle modulation to the perfect vortex light to generate vortex speckle illumination. In other embodiments, the second mirror 11 may be omitted, and the perfect vortex light emerging from the first lens 1 is directly incident onto the rotating diffuser 12. In other embodiments, the rotating diffuser 12 may be replaced by a digital micromirror device loaded with a dynamic speckle pattern.

The Köhler illumination unit is a second lens 2. The second lens 2 is placed at a distance of one focal length from the rotating diffuser 12 and is configured to perform an optical Fourier transform on the vortex speckle emerging from the rotating diffuser 12 and to output uniformly intense vortex speckle illumination to the reflection-mode imaging unit.

The reflection-mode imaging unit is a Michelson interferometer comprising a λ/2 waveplate 13, a third lens 3, a polarizing beam splitting prism 14, a first λ/4 waveplate 15, a second λ/4 waveplate 16, a first microscope objective 17, a second microscope objective 18, a fourth lens 4, and a third mirror 19. The third lens 3 and the first microscope objective 17 form a 4f system (i.e., the back focal plane of the third lens coincides with the front focal plane of the first microscope objective). The third lens 3 and the second microscope objective 18 form a 4f system (i.e., the back focal plane of the third lens coincides with the front focal plane of the second microscope objective). The first microscope objective 17 and the fourth lens 4 form a 4f system (i.e., the back focal plane of the first microscope objective coincides with the front focal plane of the fourth lens). The second microscope objective 18 and the fourth lens 4 form a 4f system (i.e., the back focal plane of the second microscope objective coincides with the front focal plane of the fourth lens). The λ/2 waveplate 13 is configured to receive the uniformly intense vortex speckle illumination emerging from the second lens 2, adjust its polarization state, and direct it through the third lens 3 into the polarizing beam splitting prism 14. The polarizing beam splitting prism 14 is configured to adjust the optical power entering the sample arm and the reference arm such that the polarization states of the first vortex speckle illumination B entering the sample arm and the second vortex speckle illumination A entering the reference arm are mutually orthogonal. The third lens 3 forms 4f systems with both the first microscope objective 17 and the second microscope objective 18, respectively transmitting the vortex speckle illumination to the sample and to the third mirror 19. The reflections from the sample and the third mirror generate signal light and reference light, respectively, which are then transmitted via the 4f systems formed by the first microscope objective 17 and the fourth lens 4, and by the second microscope objective 18 and the fourth lens 4, respectively, to the common-path interferometer. Specifically, the first λ/4 waveplate 15 and the first microscope objective 17 are disposed in the sample arm. The first vortex speckle illumination B split by the polarizing beam splitting prism 14 passes sequentially through the first λ/4 waveplate 15 and the first microscope objective 17 to illuminate the sample. The sample reflects the light to generate signal light. The second λ/4 waveplate 16, the second microscope objective 18, and the third mirror 19 are disposed in the reference arm. The second vortex speckle illumination A split by the polarizing beam splitting prism 14 passes sequentially through the second λ/4 waveplate 16 and the second microscope objective 18 to illuminate the third mirror 19. The third mirror 19 reflects the light to generate reference light. The first λ/4 waveplate 15 is configured to modulate the polarization state of the first vortex speckle illumination B to circular polarization, and the second λ/4 waveplate 16 is configured to modulate the polarization state of the second vortex speckle illumination A to circular polarization. After the resulting signal light and reference light pass again through the first λ/4 waveplate 15 and the second λ/4 waveplate 16, respectively, their polarization states are rotated by 90° relative to the polarization states of the vortex speckle illuminations originally entering the sample arm and the reference arm, thereby ensuring that the signal light and reference light can continue to be transmitted to the common-path interferometer after passing through the polarizing beam splitting prism 14. That is, the signal light passes sequentially through the first microscope objective 17, the first λ/4 waveplate 15, and the polarizing beam splitting prism 14, then enters the fourth lens 4, and subsequently enters the common-path interferometer. The reference light passes sequentially through the second microscope objective 18, the second λ/4 waveplate 16, and the polarizing beam splitting prism 14, then enters the fourth lens 4, and subsequently enters the common-path interferometer. In the above Michelson interferometer, the first objective lens and the second objective lens are microscope objectives. In other embodiments, the first objective lens and the second objective lens may also be microlenses or other types of objective lenses. Furthermore, in other embodiments, the polarizing beam splitting prism may be replaced by a fiber-optic polarizing beam splitting device.

In the above Michelson interferometer, optical sectioning is achieved by introducing a time-gating effect via the vortex speckle illumination. After axial scanning of the sample, intensity images of the sample are obtained. The common-path interferometer is configured to process the intensity images generated by the reflection-mode imaging unit to obtain interferometric images of the sample at different axial positions. In this embodiment, the common-path interferometer is configured to receive the signal light and reference light transmitted from the Michelson interferometer and to cause the signal light and reference light to interfere, thereby obtaining interferometric images. In this embodiment, the common-path interferometer comprises a Wollaston prism 20, a fifth lens 5, a sixth lens 6, and a polarizer 21. The detection unit is a camera 22. The fifth lens 5 and the sixth lens 6 form a 4f system (i.e., the back focal plane of the fifth lens coincides with the front focal plane of the sixth lens). The Wollaston prism 20 is placed at the back focal plane of the fourth lens 4 and also at the front focal plane of the fifth lens 5. The camera 22 is placed at the back focal plane of the sixth lens 6. The Wollaston prism 20 is configured to receive the signal light and reference light emerging from the fourth lens 4 of the Michelson interferometer, separate the signal light and reference light, which have mutually orthogonal polarization states, at a predetermined angle, and direct them through the fifth lens 5 to the sixth lens 6, where they recombine at the back focal plane of the sixth lens 6. The polarizer 21 is placed between the camera 22 and the sixth lens 6. The polarization direction of the polarizer 21 is oriented at 45° relative to both the signal light and the reference light, thereby causing the signal light and reference light to interfere, and interferometric images are obtained at the imaging plane of the camera 22. These interferometric images are used for 3D phase reconstruction of the sample.

As shown in FIG. 1B, interferometric images observed on the camera 22 of FIG. 1A and the corresponding camera grayscale histograms are presented. It can be seen that well-defined interference fringes are obtained using the microscope shown in FIG. 1A, which are sufficient to ensure high-quality phase imaging and enable three-dimensional phase reconstruction of the sample.

According to embodiments of the present application, by utilizing the low scattering coefficient and low absorption coefficient of near-infrared light in semiconductor materials and biological tissues, the imaging depth of the microscope (i.e., the near-infrared quantitative phase microscopy, NIR-QPM) can be significantly improved. In the present application, the microscope achieves millimeter-scale imaging depth (imaging depth greater than 1 mm) in scattering media such as three-dimensional stacked semiconductor samples or biological tissue phantoms.

To investigate the imaging depth of the microscope in biological tissue phantoms, a biological tissue phantom composed of 2 vol % Intralipid and 98 vol % water was used in this study. This biological tissue phantom exhibits optical properties similar to those of bovine muscle tissue.

Phase reconstruction of red blood cell samples was demonstrated at an imaging depth of 1.5 mm within the biological tissue phantom. Furthermore, the spatial resolution and optical sectioning capability of the proposed microscope were investigated. According to embodiments of the present application, theoretical modeling was performed to study the modulation of the point spread function (PSF) and coherent transfer function (CTF) under 1300 nm wavelength illumination as a function of vortex light modulation, and their effects on spatial resolution and optical sectioning capability were analyzed. Experimental results demonstrate that the embodiments of the present application achieve a spatial resolution of 600 nm laterally and 1100 nm axially, with an optical sectioning precision of 0.8 μm.

To address the challenges in 3D structural characterization of stacked chips, where existing methods suffer from insufficient spatial precision and slow imaging speed, making it impossible to achieve both deep imaging and fast imaging simultaneously, the present application enables high-precision characterization and defect detection of three-dimensional stacked chip samples through axial scanning.

By introducing a near-infrared light source into quantitative phase microscopy, the present application enhances the penetration depth of the reflection-mode imaging unit within the sample. To achieve three-dimensional phase reconstruction of structures embedded at large depths within the sample, a 3D reconstruction model can be established based on accurate simulation of light propagation, and 3D phase reconstruction can be realized through axial scanning. Theoretical modeling has determined that under near-infrared illumination conditions, the axial scanning precision can reach the micrometer scale, which is more than twice the scanning precision of current tomographic techniques.

In the embodiments, observation of polymer bead samples positioned beneath a 1.5-mm-thick biological tissue phantom was achieved. Furthermore, the proposed microscope can also be used for effective large-depth defect detection in three-dimensional stacked samples, such as buried defects in stacked chips. By utilizing the low scattering and low absorption characteristics of near-infrared light in semiconductor materials, the detection depth is enhanced, and quantitative phase imaging methods are subsequently employed to achieve effective defect measurement.

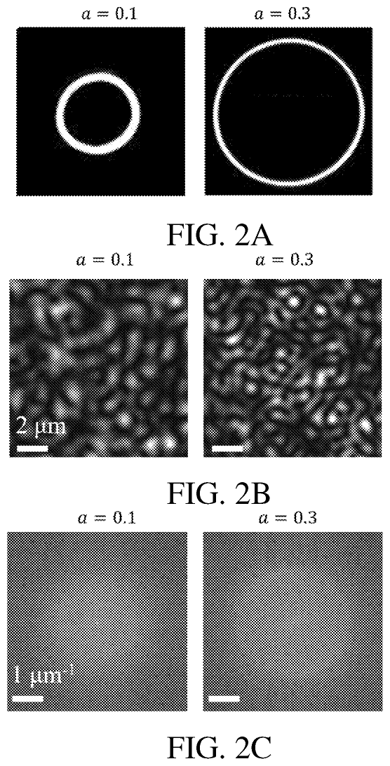

FIG. 2A shows the annular intensity distributions of vortex light in the embodiments for a of 0.1 and 0.3, respectively. As a increases, the size of the vortex light increases. FIG. 2B shows the intensity distributions of vortex speckle for a of 0.1 and 0.3, respectively. As the vortex light diameter increases, the speckle size gradually decreases. FIG. 2C shows the spatial frequency spectra of vortex speckle illumination for a of 0.1 and 0.3, respectively. As a increases, the spatial frequency bandwidth gradually broadens.

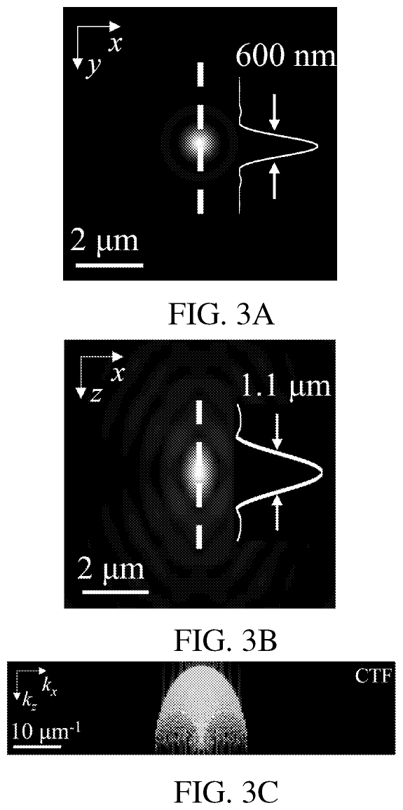

FIGS. 3A-3C present theoretical simulation results of the point spread function and coherent transfer function in the embodiments. Simulations were performed using a near-infrared light source with a wavelength of 1300 nm, an objective lens numerical aperture of 1.0, and the spatial frequency spectrum corresponding to a=0.3. FIG. 3A shows the distribution of the point spread function in the x-y plane, from which a lateral resolution of 600 nm can be observed. FIG. 3B shows the distribution of the point spread function in the x-z plane, from which an axial resolution of 1100 nm can be observed. FIG. 3C shows the distribution of the coherent transfer function in the kₓ-k_{z} plane, from which the microscope addresses the missing-cone problem. As demonstrated in FIGS. 2A-3C, compared with conventional Gaussian speckle illumination, vortex speckle illumination further extends the spatial frequency of the microscope, thereby improving spatial resolution.

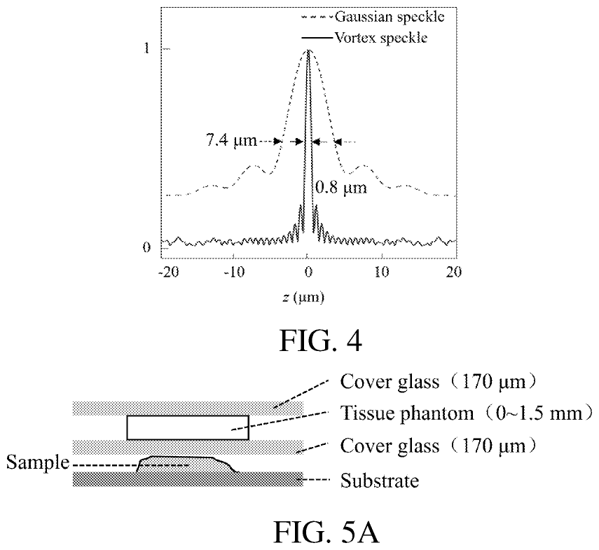

FIG. 4 shows a comparison of optical sectioning capability between vortex speckle illumination and Gaussian speckle illumination at a=0.3. This comparison of optical sectioning capability is derived from simulation results obtained by performing a Fourier transform on the coherent transfer function distribution in the kₓ-k_{z} plane at kₓ=0 and k_{y}=0. From the comparison of optical sectioning precision shown in FIG. 4, the performance of the time-gating effect induced by speckle illumination is further enhanced by vortex speckle illumination; that is, the optical sectioning precision of vortex speckle is significantly improved compared with that of conventional speckle illumination.

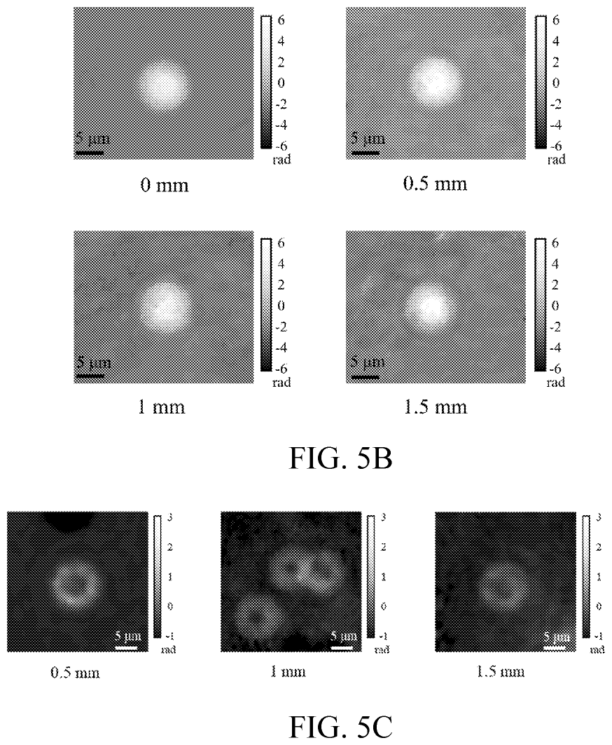

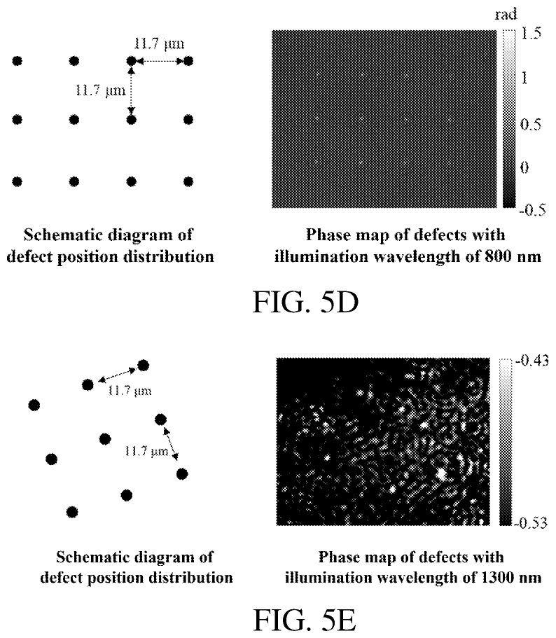

FIG. 5A shows a schematic structural diagram of the biological tissue phantom used to validate the imaging depth of the embodiments. A sample (e.g., polystyrene bead samples, red blood cell samples, etc.) is placed on a substrate, and a coverslip, the biological tissue phantom, and another coverslip are sequentially placed on top of the sample. The sample is measured through the upper coverslip using the microscope of the present application. FIG. 5B shows phase images of polystyrene bead samples (10 mm in diameter) measured at the bottom of the biological tissue phantom for tissue phantom thicknesses of 0 mm, 0.5 mm, 1 mm, and 1.5 mm. FIG. 5C shows phase images of red blood cell samples measured at the bottom of the biological tissue phantom for tissue phantom thicknesses of 0.5 mm, 1 mm, and 1.5 mm. FIG. 5D shows detection results of deposition defects buried under a stacked nitride/oxide multilayer film structure in a three-dimensional stacked chip sample using an illumination wavelength of 800 nm, where the defect size is 80 nm. FIG. 5E shows detection results of deposition defects buried under a stacked nitride/oxide multilayer film structure in a three-dimensional stacked chip sample using an illumination wavelength of 1300 nm, where the defect size is 110 nm.

In summary, the microscope of the present application exhibits the following characteristics: the use of near-infrared illumination reduces the scattering and absorption of the illumination light (i.e., vortex speckle illumination) by the sample, enhances the penetration depth of the illumination light within the sample, achieves a high imaging depth, and enables 3D phase reconstruction of the sample via quantitative phase imaging; the use of vortex speckle illumination in conjunction with a reflection-mode imaging configuration introduces a time-gating effect (realized by the vortex speckle illumination), thereby achieving optical sectioning; the annular intensity distribution of the vortex light further increases the illumination numerical aperture of the microscope compared to conventional laser speckle illumination, thereby improving the spatial frequency while also enhancing optical sectioning precision, enabling high-precision 3D phase reconstruction; and the optical sectioning effect can be exploited to perform 3D phase reconstruction of millimeter-scale sample structures through axial scanning. Thus, the present application provides a new tool for high-precision 3D quantitative detection and characterization of millimeter-scale scattering media. Through the combination of an optimized NIR illumination wavelength, vortex speckle illumination, and reflection-mode imaging, high-resolution characterization and detection at millimeter-scale depths can be achieved.

The above descriptions are further detailed explanations of the present invention based on specific/preferred embodiments, and shall not be construed as limiting the specific implementations of the present invention to these descriptions. For those of ordinary skill in the art to which the present invention pertains, various substitutions or modifications may be made to the described embodiments without departing from the inventive concept, and such substitutions or modifications shall fall within the scope of protection of the present invention. In the description of this specification, reference to terms such as “one embodiment”, “some embodiments”, “preferred embodiment”, “example ”, “specific example”, or “some examples” means that a particular feature, structure, material, or characteristic described in connection with the embodiment or example is included in at least one embodiment or example of the present invention. The schematic representations of the above terms in this specification do not necessarily refer to the same embodiment or example. Furthermore, the particular features, structures, materials, or characteristics may be combined in any suitable manner in any one or more embodiments or examples. Unless mutually inconsistent, those skilled in the art may combine and assemble different embodiments or examples, as well as features of different embodiments or examples, described in this specification. Although the embodiments of the invention and their advantages have been described in detail, it should be understood that various changes, substitutions, and alterations can be made herein without departing from the scope of protection of the patent application.

What is claimed is:

1. A reflection-mode quantitative phase microscope based on near-infrared vortex speckle illumination, comprising:
a vortex light generation unit configured to generate vortex light in the near-infrared band;
a random speckle modulation unit configured to apply random speckle modulation to the vortex light to obtain vortex speckle;
a Köhler illumination unit configured to perform an optical Fourier transform on the vortex speckle to output uniformly intense vortex speckle illumination;
a reflection-mode imaging unit configured to direct the uniformly intense vortex speckle illumination output from the Köhler illumination unit through an objective lens onto a sample, achieve optical sectioning by introducing a time-gating effect, perform axial scanning of the sample, and collect signal light reflected from the sample to obtain intensity images of the sample;
a common-path interferometer configured to process the intensity images to obtain interferometric images of the sample at different axial positions; and
a detection unit configured to collect the interferometric images, wherein the interferometric images are used for 3D phase reconstruction of the sample.

2. The reflection-mode quantitative phase microscope based on near-infrared vortex speckle illumination according to claim 1, wherein the vortex light is a perfect vortex light, and the vortex light generation unit comprises a near-infrared light source and generates the vortex light by means of laser oscillation or phase modulation.

3. The reflection-mode quantitative phase microscope based on near-infrared vortex speckle illumination according to claim 2, wherein, when the vortex light generation unit generates the vortex light by means of phase modulation, the vortex light generation unit further comprises a phase modulator and a first lens;
the near-infrared light source is configured to generate Gaussian light;
the phase modulator is configured to phase-modulate the Gaussian light to generate a Bessel beam;
the distance between the first lens and the phase modulator is equal to the focal length of the first lens, and the first lens is configured to perform an optical Fourier transform on the Bessel beam and to obtain the perfect vortex light at the back focal plane of the first lens.

4. The reflection-mode quantitative phase microscope based on near-infrared vortex speckle illumination according to claim 3, wherein the phase modulator is a spatial light modulator or a phase plate.

5. The reflection-mode quantitative phase microscope based on near-infrared vortex speckle illumination according to claim 2, wherein the near-infrared light source is one of: a semiconductor laser, a fiber laser, or a solid-state laser; the type of laser output by the near-infrared light source is one of: single-frequency laser, single-wavelength laser, supercontinuum laser, random laser, ultrafast laser, or amplified spontaneous emission laser; the near-infrared light source is configured for continuous-wave or pulsed output.

6. The reflection-mode quantitative phase microscope based on near-infrared vortex speckle illumination according to claim 1, wherein the vortex speckle illumination is dynamic speckle; the random speckle modulation unit comprises a rotating diffuser or a digital micromirror device loaded with a dynamic speckle pattern, and the rotating diffuser or the digital micromirror device loaded with a dynamic speckle pattern is configured to apply random speckle modulation to the vortex light to obtain the vortex speckle.

7. The reflection-mode quantitative phase microscope based on near-infrared vortex speckle illumination according to claim 1, wherein the Köhler illumination unit is a second lens.

8. The reflection-mode quantitative phase microscope based on near-infrared vortex speckle illumination according to claim 1, wherein the reflection-mode imaging unit is a Michelson interferometer.

9. A reflection-mode quantitative phase imaging method based on near-infrared vortex speckle illumination, comprising the following steps:
S1: generating vortex light in the near-infrared band;
S2: applying random speckle modulation to the vortex light to obtain vortex speckle;
S3: performing an optical Fourier transform on the vortex speckle to obtain uniformly intense vortex speckle illumination;
S4: directing the uniformly intense vortex speckle illumination through an objective lens onto a sample in a reflection-mode imaging configuration, achieving optical sectioning by introducing a time-gating effect, performing axial scanning of the sample, and collecting signal light reflected from the sample to obtain intensity images of the sample;
S5: processing the intensity images via a common-path interferometric scheme to obtain interferometric images of the sample at different axial positions; and
S6: collecting the interferometric images to achieve 3D phase reconstruction of the sample.
